(19) United States
(12) Patent Application Publication
(10) Pub. No.: US 2005/0174481 A1
(43) Pub. Date: Aug. 11, 2005

(54) Bias circuit to prevent distortion of color in a cathode ray tube

(76) Inventor: Han-sung Kim, Yeonsu-gu (KR)

Correspondence Address: STANZIONE & KIM, LLP, 1740 N STREET, N.W., FIRST FLOOR, WASHINGTON, DC, 20036, US

(21) Appl. No.: 11/030,181

(22) Filed: Jan. 7, 2005

(30) Foreign Application Priority Data
Feb. 9, 2004 (KR) 2004-8393

(51) Int. Cl. H04N 5/68

(52) U.S. Cl. 348/379; 348/707

(57) ABSTRACT

A bias circuit to prevent distortion of color in a cathode ray tube (CRT) comprises a power supply part, a first amp to amplify and output a brightness control voltage applied to control brightness, a second amp to respectively amplify and output RGB-bias control voltages having a ratio of R:G:B supplied from a video power amp, an addition amp to add the brightness control voltage output from the first amp respectively to the RGB-bias control voltages amplified and output from the second amp and to amplify the respective added values to output the respective added RGB-bias control voltages, and an inverting amp to restore the respective added RGB-bias control voltages input from the addition amp and to calculate respective output RGB bias control voltages. Accordingly, color distortion of a video image caused after changing brightness of a screen can be prevented so that a correct color of the image can be implemented.

### CROSS-REFERENCE TO RELATED APPLICATIONS

This application claims the benefit of Korean Application No. 2004-8393, filed Feb. 9, 2004, in the Korean Intellectual Property Office, the disclosure of which is incorporated herein in its entirety by reference.

### BACKGROUND OF THE INVENTION

1. Field of the Invention

The present general inventive concept relates to a bias circuit in a cathode ray tube (CRT). More particularly, the present general inventive concept relates to a bias circuit to prevent distortion of color in a CRT by equalizing a color combination rate of red-green-blue (RGB) colors even after a user changes brightness of a screen.

2. Description of the Related Art

General video display apparatuses are input with a video signal and a synchronization signal received from a video card of a computer, thereby displaying the video on a cathode ray tube (CRT) screen. The CRT used in a video display apparatus is based on a principle where electron beams of different amounts according to intensity of the video signals hit red, green, and blue (RGB) phosphors coated on a surface of the CRT, thereby emitting lights of different brightness and colors. The CRT is widely used due to its low price and its excellent display performance.

FIG. 1 illustrates a block diagram of a general video display apparatus comprising a deflection part 1, a high-pressure part 2, a micro computer 3, a video preamplifier (preamp) 4, a video power amplifier (amp) 5, and a bias circuit part 40. The video preamp 4 primarily amplifies RGB video signals input from a computer, and the video power amp 5 re-amplifies the pre-amplified RGB video signals to drive a cathode of the CRT. The bias circuit part 40 supplies electric power to the respective RGB video signals to control a voltage level of the RGB video signals, which are supplied from the video power amp 5 to the cathode of the CRT.

FIG. 2 illustrates a circuit view of a conventional bias circuit part. Referring to FIG. 2, the operation of the conventional bias circuit part 40 will be described.

The conventional bias circuit part 40 comprises bias voltage amps 44, 46, and 48 for respective RGB colors and a brightness controller 42. The RGB-bias voltage amps 42, 44, and 46 separately amplify RGB-bias voltages input by the video power amp 5 (FIG. 1) to respective RGB-bias input terminals into desired voltages. The brightness controller 42 controls levels of the RGB-bias voltages as a whole.

Since the RGB-bias voltage amps 44, 46, and 48 operate in the same manner, only the operation of the R-bias voltage amp 42 will be described. The R-bias voltage supplied to the R-bias input terminal is amplified when it passes through a first transistor T1 and a fourth transistor T4 and then output through an R-bias output terminal to supply bias voltage to the R video signal.

During this process, an amplification rate is controlled by the brightness controller 42. If a brightness control voltage input to a base terminal B of a transistor T7 is changed, voltage of an emitter terminal E of the transistor T7 is also changed. As a result, a voltage of an emitter terminal E of the first transistor T1 that amplifies the R-bias voltage is also changed. Accordingly, the amplification rate of the R-bias voltage is controlled.

When the brightness controller 42 of the bias circuit part 40, operated in the manner described above, controls the brightness control voltage, the RGB-bias voltage amps 44, 46, and 48 are controlled thereby increasing and decreasing the RGB-bias voltages by the same rate.

Color of video images in the CRT is determined according to an R:G:B cathode voltage ratio. A cathode voltage is determined by the RGB-bias voltages.

In the conventional bias circuit part 40, as the RGB-bias voltages are increased or decreased according to a change in brightness, the R:G:B cathode voltage ratio is also increased or decreased by the same rate. For instance, if a ratio of the RGB-bias voltages is R:G:B before the change in brightness, and the RGB-bias voltages are increased by 6 according to the change in brightness, the ratio of the RGB-bias voltages becomes R+δ:G+δ:B+δ after the brightness change.

However, R:G:B is typically not equal to R+δ:G+δ:B+δ. In other words, since the RGB-bias voltage ratios before and after the brightness change are not equal, the R:G:B cathode bias voltage ratios are also changed after the change in brightness. As a result, distortion is generated in the color of the video images.

Due to the color distortion caused by the change in brightness, a user's demand for exact color implementation cannot be satisfied even though display products that can implement exact colors become necessary for graphic works, home shopping, and internet shopping.

### SUMMARY OF THE INVENTION

The present general inventive concept provides a bias circuit to prevent distortion of color in a cathode ray tube (CRT), in which a ratio of red-green-blue (RGB) bias voltages is stabilized even after brightness of a screen is changed by compensating each of the RGB-bias voltages by a different amount according to input RGB-bias voltages.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a bias circuit to prevent distortion of color in a cathode ray tube (CRT) comprising a power supply part, a first amplifier (amp) to amplify and output a brightness control voltage applied to control brightness, a second amp to amplify and output RGB-bias control voltages having a ratio of R:G:B supplied from a video power amp, an addition amp to add the brightness control voltage output from the first amp respectively to the RGB-bias control voltages amplified and output from the second amp and to amplify the respective added values and output the respective added RGB bias control voltages, and an inverting amp to restore the respective added RGB bias control voltages input from the addition amp to the ratio of R:G:B and to calculate respective restored output RGB bias voltages.

The bias circuit may further comprise a plurality of resistances to generate a predetermined voltage by dividing a power voltage supplied from the power supply part.

The predetermined voltage is added to the brightness control voltage and the respective RGB-bias control voltages in order to control voltages input to the addition amp according to the predetermined voltage.

The first amp may comprise at least one resistance connected in series with a brightness control voltage input terminal, an operational amp connected in series with an end of the at least one resistance by a negative (−) input terminal and grounded by a positive (+) terminal, and at least one transistor connected to the operational amp in parallel.

The at least one transistor is connected in a manner that a collector terminal is connected to a connection point between the (−) input terminal of the operational amp and the at least one resistance, an emitter terminal is connected to an output terminal of the operational amp, and a base terminal is grounded.

The second amp comprises an R-bias control voltage amp having at least one resistance, at least one transistor, and at least one operational amp to amplify and output the R-bias control voltage; a G-bias control voltage amp having at least one resistance, at least one transistor, and at least one operational amp to amplify and output the G-bias control voltage; and a B-bias control voltage amp having at least one resistance, at least one transistor, and at least one operational amp to amplify and output the B-bias control voltage.

The addition amp comprises a first addition amp to add the amplified brightness control voltage, the amplified R-bias control voltage, and the predetermined voltage, and to amplify and output the added R-bias control voltage; a second addition amp to add the amplified brightness control voltage, the amplified G-bias control voltage, and the predetermined voltage, and to amplify and output the added G-bias control voltage; and a third addition amp to add the amplified brightness control voltage, the amplified B-bias control voltage, and the predetermined voltage, and to amplify and output the added B-bias control voltage.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a block diagram of a general video display apparatus;

FIG. 2 illustrates a schematic circuit view of a conventional bias circuit of a cathode ray tube (CRT);

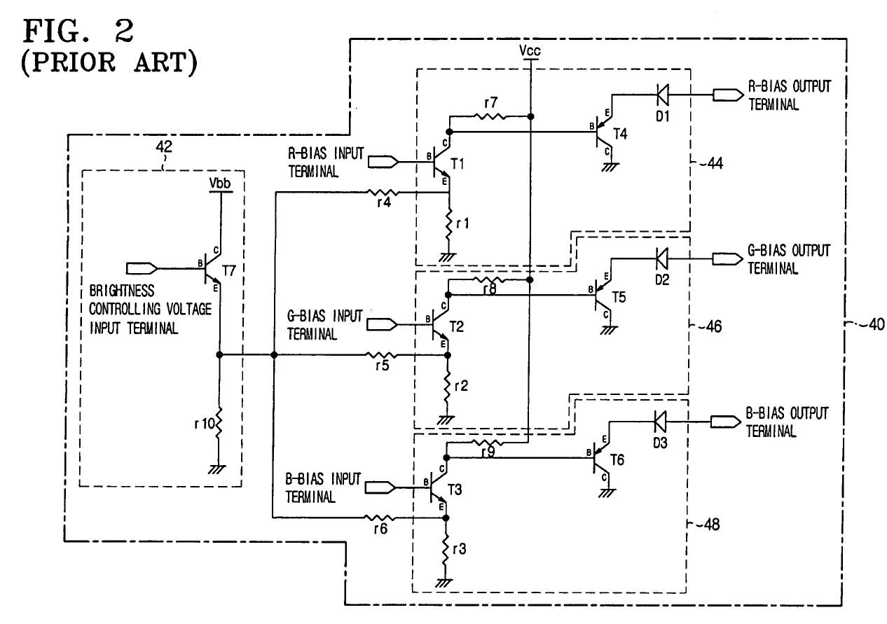

FIG. 3 illustrates a schematic circuit view of a bias circuit to prevent color distortion in a CRT according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

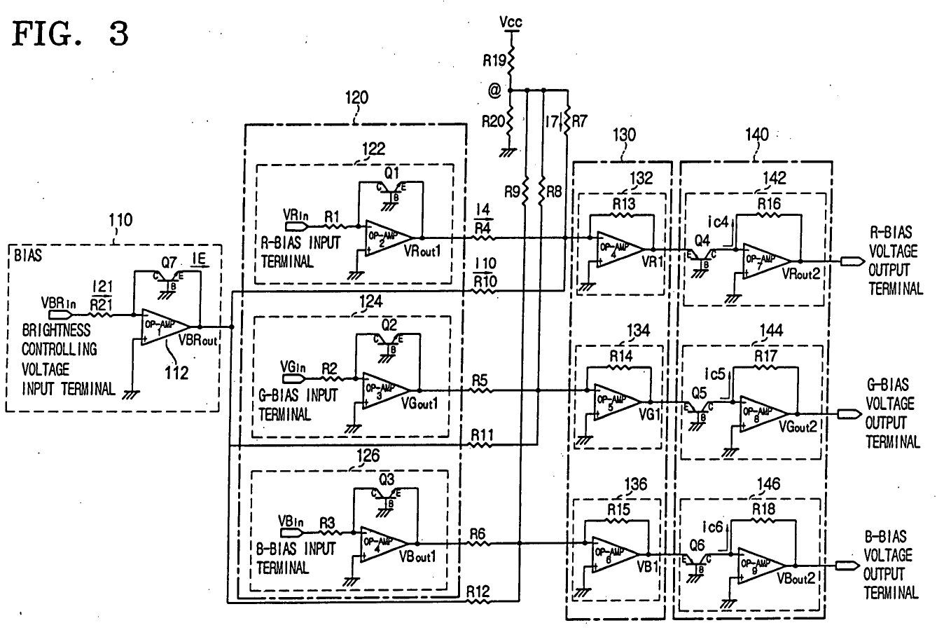

FIG. 3 illustrates a schematic circuit view of a bias circuit to prevent color distortion in a CRT according to an embodiment of the present general inventive concept. Referring to FIG. 3, the bias circuit to prevent color distortion comprises a first amplifier (amp) 110, a second amp 120, an addition amp 130, and an inverting amp 140.

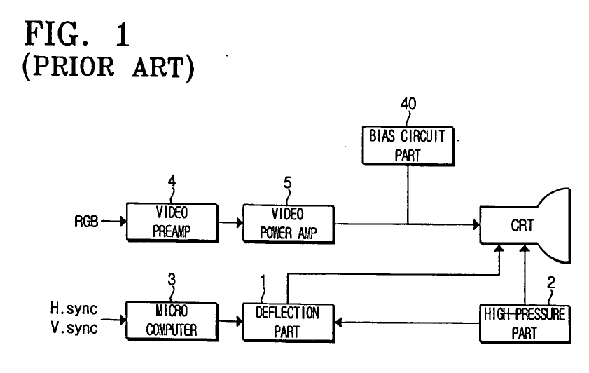

The first amp 110 comprises at least one resistance, at least one operational amp, and at least one transistor. The first amp 110 amplifies and outputs a brightness control voltage VBRin, which is input from a video power amp 5 (FIG. 1).

The second amp 120 comprises an R-bias voltage amp 122, a G-bias voltage amp 124, and a B-bias voltage amp 126. The respective bias voltage amps 122, 124, and 126 independently amplify RGB-bias voltages input to respective input terminals. The respective bias voltage amps 122, 124, and 126 have at least one resistance, at least one operational amp, and at least one transistor. The second amp 120 amplifies and outputs the RGB-bias voltages input from the video power amp 5 (FIG. 1).

The addition amp 130 comprises a first addition amp 132, a second addition amp 134, and a third addition amp 136. The first addition amp 132 is connected to an output terminal of the R-bias voltage amp 122 through a resistance R4 and is connected to an output terminal of the first amp 110 through a resistance R10. The first addition amp 132 is also connected to a connection spot @ between a resistance R19 and a resistance R20 through a resistance R7.

The second addition amp 134 is connected to an output terminal of the G-bias voltage amp 124 through a resistance R5 and is connected to the output terminal of the first amp 110 through a resistance R11. The second addition amp 134 is also connected to the connection spot @ between the resistance R19 and the resistance R20 through a resistance R8.

Similarly, the third addition amp 136 is connected to an output terminal of the B-bias voltage amp 126 through a resistance R6 and is connected to the output terminal of the first amp 110 through a resistance R12. The third addition amp 136 is also connected to the connection spot@ between the resistance R19 and the resistance R20 through a resistance R9.

The brightness control voltage VBRin, amplified and output by the first amp 110, is added to each of the respective input RGB-bias voltages amplified and output by the bias voltage amps 122, 124, and 126. The added voltages VR1, VG1, and VB1 are then amplified and output.

The inverting amp 140 comprises an R-bias voltage calculator 142, a G-bias voltage calculator 144, and a B-bias voltage calculator 146. The inverting amp 140 calculates respective output RGB-bias voltages by restoring the added voltages VR1, VG1, and VB1 amplified and output by the addition amp 130.

The RGB-bias voltage calculators 142, 144, and 146 each comprise at least one transistor, at least one resistance, and at least one operational amp.

The brightness control voltage VBRin is applied to an input terminal of the first amp 110 from the video power amp 5 (FIG. 1). The brightness control voltage VBRin is amplified when it passes through a first operational amp 112 in the first amp 110, which comprises a transistor Q7 and a resistance R21. Assuming that an emitter current of the transistor Q7 is I_{E}, the relationship between the I_{E} and V_{BE} (i.e., a voltage between a base B and the emitter E) is expressed by [Equation 1] as follows.
I_{E}=I_{S}·exp(V_{BE}/V_{T}) [Equation 1]

In [Equation 1], V_{T}=kT/q, Iₛ denotes a reverse saturation current constant of the transistor Q7, V_{T} denotes a thermal voltage constant of the transistor Q7, k denotes Baltzman's constant (1.38×10⁻²³ J/°K), T denotes absolute temperature, and q denotes electric charge (1.6×10⁻¹⁹ Coulomb).

When the brightness control voltage VBRin input to the first amp 110 changes, a current 121 at the resistance R21 is thoroughly absorbed by the transistor Q7, and a voltage input to a negative (−) terminal of the first operational amp 112 becomes 0. Therefore, I₂₁=VBRin/R₂₁=I_{c}=αI_{E}. I_{E} is expressed below.
I_{E}=VBRin/αR₂₁;
wherein, α denotes an amplification rate of the transistor Q7.

An output voltage VBRout of the first amp 110 (i.e., ah amplified brightness control voltage) is calculated as follows.
VBRout=−V_{T}·ln(I_{E}/I_{S})=−V_{T}·ln(VBRin/αR₂₁Iₛ)

In the above equation, a variable may be substituted for a constant related to a property of matter as in [Equation 2] below.
VBRₒᵤₜ=−a·ln(VBRin/R₂₁)+b [Equation 2]

A relationship between the brightness control voltage VBRin input to the first amp 110 and the amplified brightness control voltage VBRout output from the first amp 110 can be understood from [Equation 2].

When input RGB-bias voltages VRin, VGin, and VBin are applied to the respective RGB-bias input terminals of the second amp 120, the second amp 120 operates in the same manner as the first amp 110. Further, since the RGB-bias voltage amps 122, 124, and 126 of the second amp 120 operate in the same manner, only operation of the R-bias voltage amp 122 will be described.

An output R-bias voltage VRout1 of the R-bias voltage amp 122 in the second amp 120 can be expressed using [Equation 3] as follows.
VRout1=−a1·ln(VRin/R1)+b1 [Equation 3]

In [Equation 3], VRin denotes the input R-bias voltage. Likewise, an output G-bias voltage and B-bias voltage are expressed as VGout1=−a2·ln(VGin/R2)+b2 and VBout1=−a3·ln(VBin/R3)+b3, respectively.

The addition amp 130 amplifies by adding the amplified brightness control voltage VBRout output by the first amp 110 to the respective output RGB-bias voltages VRout1, VGout1, and VBout1. The operation of the first addition amp 132 connected to the R-bias voltage amp 122 will be described hereinbelow.

A current I₄ flowing in the resistance R4 is expressed by VRout1/R4, a current I₁₀ flowing in the resistance R10 is VBRout1/R10, and a current I₇ flowing in the resistance R7 is V_{@}/R7. V_{@} denotes the voltage at the connection spot @ between the resistance R19 and the resistance R20.

An output voltage VR1 of the first addition amp 132 is expressed as the following.

$$\begin{matrix}VR1 = - R13 ( {I}_{4} + {I}_{10} + {I}_{7} ) \\ = - R13 ( VRout1 / R4 ) + ( VBRout / R10 ) + ( {V}_{@} / R7 )\end{matrix}$$

Here, since R4=R7=R10, the above equation can be expressed by [Equation 4] as follows.

$$VR1 = \frac{R13}{R4} [ ( a ln ( \frac{VBRin}{R21} ) + b ) + ( a ln ( \frac{VBRin}{R1} ) + b ) - {V}_{@} ] \qquad [ Equation 4 ]$$

In [Equation 4], by controlling a resistance ratio of the resistance R19 and the resistance R20 such that V_{@}, voltage of the spot@, becomes 2b, and the first resistance R1 becomes the same as the resistance R21, the output voltage VR1 of the first addition amp 132 can be expressed by [Equation 5] as below.

$$VR1 = \frac{a1R13}{R4} ln ( \frac{VBRin \cdot VRin}{R1} ) \qquad [ Equation 5 ]$$

As in the first addition amp 132, an output voltage VG1 of the second addition amp 134 is expressed as below.

$$VG1 = \frac{a2R14}{R2} ln ( \frac{VBRin \cdot VGin}{R2} )$$

An output voltage VB1 of the third addition amp 136 is expressed as below.

$$VB1 = \frac{a3R15}{R3} ln ( \frac{VBRin \cdot VBin}{R3} )$$

The R-bias voltage calculator 142 in the inverting amp 140 restores the voltage amplified and output by the addition amp 130 to calculate a final output R-bias voltage VRout2. In [Equation 3], if VR1 of [Equation 5] is applied for VRout1, and the final output R-bias voltage VRout2 is applied for VRin, [Equation 6] is obtained as the following.
VRout2=C1*(VBRin*VRin) [Equation 6]

Also, VGout2=C2*(VBRin*VGin), and VBout2=C3*(VBRin*VBin). Here, C1, C2 and C3 are constants.

According to [Equation 5], a ratio of the final output RGB-bias voltages VRout2, VGout2, and VBout2 becomes the same as the ratio of the input RGB-bias voltages VRin, VGin and VBin, even after the brightness change.

In essence, the above description is summarized as follows.
R-bias output voltage VRout2: G-bias output voltage VGout2: B-bias output voltage VBout2=C1*brightness control voltage VBRin*R-bias input voltage VRin: C2*brightness control voltage VBRin*G-bias input voltage VGin: C3*brightness control voltage VBRin B-bias input voltage VBin=R-bias input voltage: G-bias input voltage: B-bias input voltage

Accordingly, distortion of color, which is usually caused after the brightness change, can be prevented.

According to this embodiment of the present general inventive concept, color distortion is restrained even after brightness of an image in a display is changed by a user, thereby enabling correct colors.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A bias circuit to prevent distortion of color in a cathode ray tube (CRT) and to control a voltage level of red-green-blue (RGB) image signals by supplying bias voltages having a bias voltage ratio to the RGB image signals, which are supplied from a video power amp to a cathode of the CRT, the bias circuit comprising:
a power supply part;
a first amplifier to amplify and output a brightness control voltage applied to control brightness;
a second amplifier to respectively amplify and output RGB-bias control voltages having a ratio of R:G:B supplied from the video power amp;
an addition amp to add the brightness control voltage output from the first amp respectively to the RGB-bias control voltages amplified and output from the second amp and to amplify the respective added values to output the respective added RGB bias control voltages; and
an inverting amp to restore the respective added RGB bias control voltages input from the addition amp to the ratio of R:G:B and to calculate respective restored output RGB bias control voltages.

2. The bias circuit of claim 1, further comprising a plurality of resistances to generate a predetermined voltage by dividing a power voltage supplied from the power supply part.

3. The bias circuit of claim 2, wherein the predetermined voltage is added to the brightness control voltage and the respective RGB-bias control voltages in order to control voltages input to the addition amp according to the predetermined voltage.

4. The bias circuit of claim 1, wherein the first amp comprises:
at least one resistance connected in series with a brightness control voltage input terminal;
an operational amp connected in series with an end of the at least one resistance by a negative (−) input terminal and grounded by a positive (+) terminal; and
at least one transistor connected to the operational amp in parallel.

5. The bias circuit of claim 4, wherein the at least one transistor is connected in a manner that a collector terminal is connected to a point between a negative (−) input terminal of the operational amp and the at least one resistance, an emitter terminal is connected to an output terminal of the operational amp, and a base terminal is grounded.

6. The bias circuit of claim 1, wherein the second amp comprises:
an R-bias control voltage amp having at least one resistance, at least one transistor, and at least one operational amp to amplify and output the R-bias control voltage;
a G-bias control voltage amp having at least one resistance, at least one transistor, and at least one operational amp to amplify and output the G-bias control voltage; and
a B-bias control voltage amp having at least one resistance, at least one transistor, and at least one operational amp to amplify and output the B-bias control voltage.

7. The bias circuit of claim 1, wherein the addition amp comprises:
a first addition amp to add the amplified brightness control voltage, the amplified R-bias control voltage, and the predetermined voltage, and to amplify and output the added R-bias control voltage;
a second addition amp to add the amplified brightness control voltage, the amplified G-bias control voltage, and the predetermined voltage, and to amplify and output the added G-bias control voltage; and
a third addition amp to add the amplified brightness control voltage, the amplified B-bias control voltage, and the predetermined voltage, and to amplify and output the added B-bias control voltage.

8. The bias circuit of claim 1, wherein the ratio R:G:B of the RGB bias control voltages supplied from the video power amp is equal to a ratio of respective output R:G:B bias control voltages.

9. An apparatus to prevent color distortion in a cathode ray tube by stabilizing a color ratio of at least two color component bias voltages of a video signal, the apparatus comprising:
a bias voltage amplifying stage to receive the at least two color component bias voltages of a video signal, to separately amplify the at least two color component bias voltages, and to output the at least two color component bias voltages;
an addition amplifying stage to receive the amplified at least two color component bias voltages from the bias voltage amplifying stage, to separately add each of the at least two color component bias voltages to a brightness control voltage, and to separately amplify the added color component bias voltages; and
an inverting amplifying stage to receive the amplified at least two color component bias voltages, to restore the amplified at least two color component bias voltages to have the color ratio, and to output the amplified at least two color component bias voltages to a cathode in the cathode ray tube.

10. The apparatus of claim 9, wherein the at least two color component bias voltages include a red component bias voltage, a green component bias voltage, and a blue component bias voltage.

11. The apparatus of claim 9, wherein the at least two color component bias voltages are received from a video signal power amplifier.

12. The apparatus of claim 9, further comprising:
a brightness control voltage amplifying stage to receive the brightness control voltage, which controls an amplification rate of the at least two color component bias voltages, to amplify the brightness control voltage, and to provide the brightness control voltage to the addition amplifying stage.

13. The apparatus of claim 9, wherein the addition amplifying stage further adds a predetermined bias voltage to the at least two color component bias voltages and the brightness control voltage.

14. The apparatus of claim 13, further comprising:
a power supply to supply a voltage to the addition amplifying stage, wherein the predetermined bias voltage is determined by dividing the voltage using a first and second resistance.

15. The apparatus of claim 9, wherein the output at least two color components are equal to a multiple of the respective ones of the at least two color component bias voltages received by the bias voltage amplifying stage multiplied by the brightness control voltage.

16. The apparatus of claim 9, wherein the bias voltage amplifying stage comprises at least two bias voltage amplifiers that correspond to the at least two color component bias voltages and each of the at least two bias voltage amplifiers includes an operational amplifier and a transistor connected in parallel with the operational amplifier between a negative terminal and an output terminal.

17. The apparatus of claim 16, wherein a positive terminal of the operational amplifier is connected to ground and the negative terminal of the operational amplifier is connected to a respective input color component bias voltage through an input resistance.

18. The apparatus of claim 9, wherein the addition amplifying stage comprises at least two addition amplifiers that correspond to the at least two color component bias voltages and each of the at least two addition amplifiers includes an operational amplifier having a grounded positive terminal and a negative terminal connected to a respective color component bias voltage from the bias voltage amplifying stage and a resistance connected in parallel with the operational amplifier between an output terminal and the negative terminal.

19. The apparatus of claim 18, wherein the operational amplifier of each of the at least two addition amplifiers adds a predetermined bias voltage, the respective color component bias voltage from the bias voltage amplifying stage, and the brightness control voltage.

20. The apparatus of claim 9, wherein the inverting amplifying stage comprises at least two inverting amplifiers that correspond to the at least two color component bias voltages and each of the at least two inverting amplifiers includes an operational amplifier having a grounded positive terminal and a negative terminal connected to a respective color component bias voltage from the addition amplifying stage and a resistance connected in parallel with the operational amplifier between the negative terminal and an output terminal.

21. An apparatus to prevent color distortion in a cathode ray tube by maintaining the same color ratio between color bias voltages before and after brightness of a display is changed, the apparatus comprising:
a first amplifying means to amplify at least first and second color bias voltages having a color ratio;
a second amplifying means to receive the first and second color bias voltages from the first amplifying means, to add a brightness control voltage to the first and second color bias voltages, and to amplify the added first and second color bias voltages; and
a third amplifying means to receive the amplified first and second color bias voltages from the second amplifying means, to restore the color ratio between the amplified first and second color bias voltages, and to output the amplified first and second bias color voltages.

22. The apparatus of claim 21, further comprising:
a connection point between the first amplifying means and the second amplifying means to receive a predetermined bias voltage from a power supply, the brightness control voltage from a brightness control voltage amplifying means, and the first and second color bias voltages from an output of the first amplifying means.

23. A video display apparatus, comprising:
a bias circuit to prevent color distortion in a cathode ray tube when changing brightness in a display screen by equalizing a color ratio of at least a first color bias voltage and a second color bias voltage of a video signal, the bias circuit including:
a bias voltage amplifier to separately amplify at least the first color bias voltage and the second color bias voltage,
an addition amplifier to receive at least the first color bias voltage and the second color bias voltage from the bias voltage amplifier, to receive a brightness control voltage that determines an amplification rate of at least the first color bias voltage and the second color bias voltage, to separately add the brightness control voltage to at least the first color bias voltage and the second color bias voltage, and to amplify at least the first color bias voltage and the second color bias voltage, respectively, and
an inverting amplifier to receive the amplified at least the first color bias voltage and the second color bias voltage and to compensate for distortion by restoring the color ratio between the amplified at least the first color bias voltage and the amplified second color bias voltage and to output at least the amplified first color bias voltage and the amplified second color bias voltage.

24. A method of preventing color distortion in a cathode ray tube while changing brightness in a display screen, the method comprising:
receiving a change in a brightness control voltage and receiving at least two color bias voltages having a color ratio from a video signal;
performing a first amplifying operation on the at least two color bias voltages;
separately adding the brightness control voltage to the at least two color bias voltages and performing a second amplifying operation on the at least two color bias voltages; and
performing a third amplifying operation on the at least two color bias voltages and restoring the color ratio to the at least two color voltages.

25. The method of claim 24, further comprising:
providing the amplified at least two color bias voltages in the color ratio to a cathode in the cathode ray tube.

26. The method of claim 24, wherein the first amplifying operation is performed on the at least two color bias voltages separately by operational amplifiers.

27. The method of claim 24, wherein the at least two color bias voltages include a red color bias voltage, a green color bias voltage, and a blue color bias voltage.

28. The method of claim 24, wherein an amplification rate of the first, second, and third amplifying operations to amplify the at least two color bias voltages is equal to a multiple of the brightness control voltage multiplied by a respective one of the at least two color bias voltages.

29. A method of biasing a plurality of color component bias voltages in a video signal, the method comprising:
receiving a plurality of color component bias voltages having a predetermined bias voltage ratio and receiving a brightness control voltage;
independently amplifying the plurality of color component bias voltages by a multiple of the brightness control voltage using two or more stages of operational amplifiers, wherein an output bias voltage ratio is equal to the predetermined bias voltage ratio.
